(19) United States
(12) Patent Application Publication
(10) Pub. No.: US 2025/0008249 A1
(43) Pub. Date: Jan. 2, 2025

(54) SPEAKER UNIT AND EARPIECE

(71) Applicant: Shinobu KASAHARA, Tokyo (JP)

(72) Inventor: Shinobu KASAHARA, Tokyo (JP)

(73) Assignee: MITSUMI ELECTRIC CO., LTD., Tokyo (JP)

(21) Appl. No.: 18/748,714

(22) Filed: Jun. 20, 2024

(30) Foreign Application Priority Data
Jun. 27, 2023 (JP) 2023-104861

(51) Int. Cl. H04R 1/02; H04R 1/10; H04R 17/00

(52) U.S. Cl. CPC H04R 1/02; H04R 1/1016; H04R 17/00; H04R 2460/11

(57) ABSTRACT

A speaker unit includes a substrate and multiple piezoelectric drivers disposed on the substrate, the multiple piezoelectric drivers being configured to generate respective acoustic waves having different frequency ranges. The speaker unit includes a housing integrally including multiple housing portions that house the respective piezoelectric drivers.

### CROSS-REFERENCE TO RELATED APPLICATIONS

This application claims priority under 35 U.S.C. § 119 to Japanese Patent Application No. 2023-104861, filed Jun. 27, 2023, the contents of which are incorporated herein by reference in its entirety.

### BACKGROUND

### 1. Technical Field

The present disclosure relates to a speaker unit and an earpiece.

### 2. Description of the Related Art

A balanced armature (BA) driver is known as a driver for a speaker unit (see Patent Document 1). The BA driver includes a housing, a magnet, a coil, an armature, and a diaphragm. The magnet, the coil, the armature, and the diaphragm are housed in the housing. When a drive current flows through the coil, the armature and the diaphragm vibrate, and thus acoustic waves are generated.

### RELATED-ART DOCUMENT

### Patent Document

Patent Document 1: Japanese Unexamined Patent Application Publication No. 2017-158120

### SUMMARY

A speaker unit in the present disclosure includes a substrate and multiple piezoelectric drivers disposed on the substrate, the multiple piezoelectric drivers being configured to generate respective acoustic waves having different frequency ranges. The speaker unit includes a housing integrally including multiple housing portions that house the respective piezoelectric drivers.

### BRIEF DESCRIPTION OF THE DRAWINGS

FIG. 1 is a perspective view of a speaker unit according to a first embodiment.

FIG. 2 is a plan view of a substrate and piezoelectric drivers according to the first embodiment.

FIG. 3 is a perspective view of a housing according to the first embodiment.

FIG. 4 is a schematic view of an earpiece with the speaker unit according to the first embodiment.

FIG. 5 is a perspective view of the speaker unit according to a second embodiment.

### DETAILED DESCRIPTION

The inventor of this application has recognized the following information in related art. When acoustic waves having different frequency ranges are generated through a speaker unit with balanced armature (BA) drivers, it is necessary to provide the BA drivers that correspond to the respective frequency ranges. In addition, the respective BA drivers are required to be housed in separate housings. As a result, the speaker unit and an earpiece with the speaker unit are enlarged.

In view of the situation recognized by the inventor, an object of the present disclosure is to provide a speaker unit and an earpiece that are made compact.

Embodiments of the present disclosure will be described below with reference to the drawings. In each drawing, the same components may have the same numerals. In the description of each drawing, the description of the same components as those that have been already described may be omitted.

In each drawing, orthogonal coordinates having an X axis, a Y axis, and a Z axis are used as direction expressions. The X axis, the Y axis, and the Z axis are orthogonal to one another. An X direction along the X axis indicates a width direction of a speaker unit according to the embodiments. A Y direction along the Y axis indicates a depth direction of the speaker unit according to the embodiments. A Z direction along the Z axis indicates a thickness direction of the speaker unit according to the embodiments. In each of the X direction, the Y direction, and the Z direction, a side to which an arrow is directed is referred to as a “+ side,” and a side opposite the + side is referred to as a “− side.” However, these do not limit the orientation of the speaker unit according to the embodiments during use, and the orientation of the speaker unit according to the embodiments is arbitrary.

### First Embodiment

### Overall Configuration

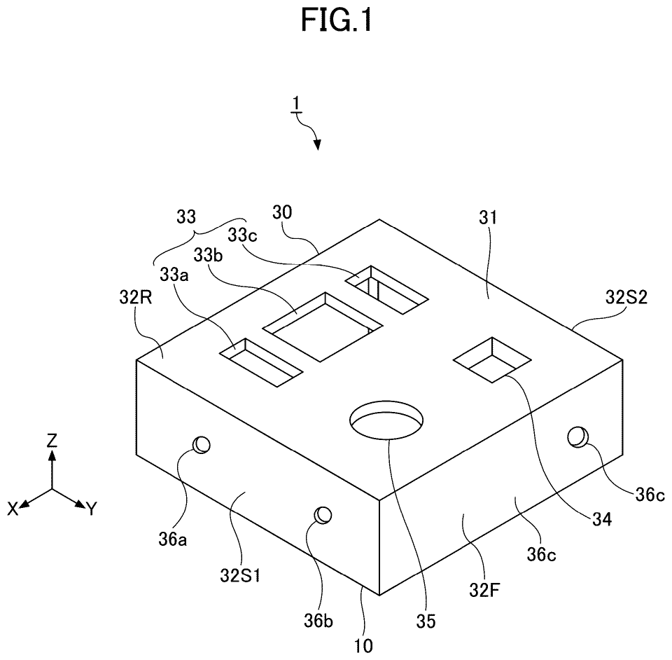

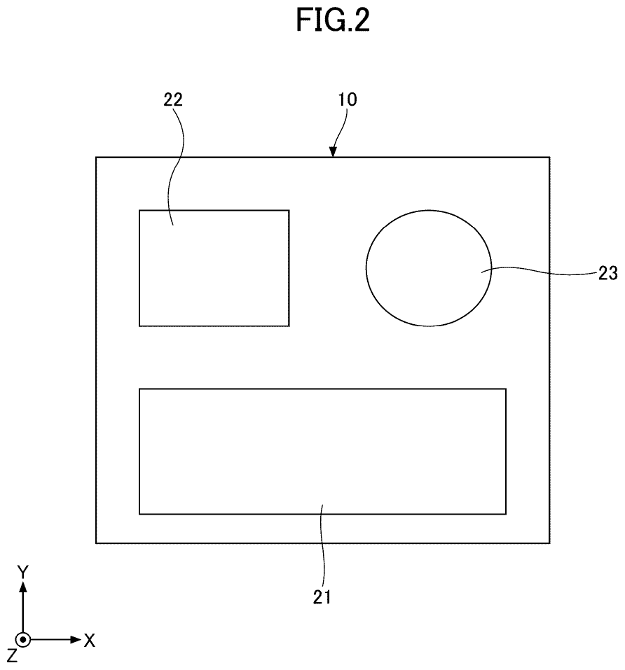

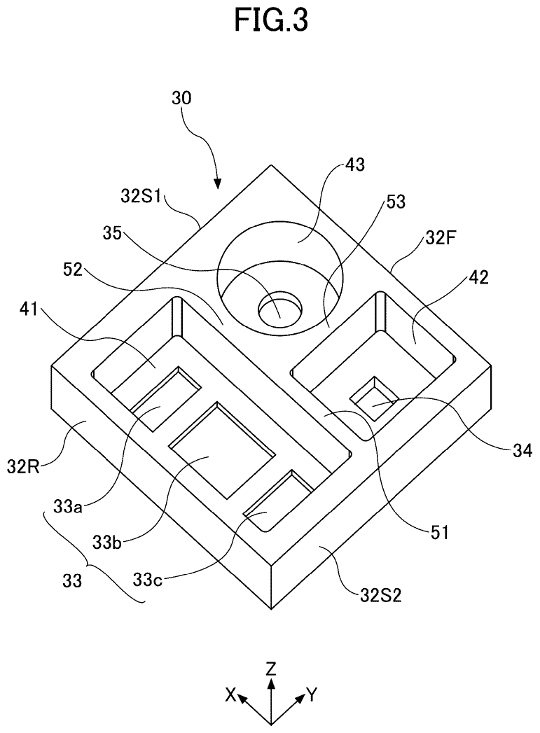

Hereinafter, a configuration example of the entire speaker unit 1 according to a first embodiment will be described with reference to FIGS. 1 to 3. FIG. 1 is a perspective view of the speaker unit 1 according to the first embodiment when viewed from a +Z side direction. FIG. 2 is a plan view of plane shapes of a substrate 10, a first piezoelectric driver 21, a second piezoelectric driver 22, and a third piezoelectric driver 23 in the speaker unit 1 according to the first embodiment. FIG. 3 is a perspective view of a housing 30 in the speaker unit 1 when viewed from a −Z side direction according to the first embodiment.

As shown in FIGS. 1 to 3, the speaker unit 1 includes the substrate 10, the first piezoelectric driver 21, the second piezoelectric driver 22, the third piezoelectric driver 23, and the housing 30. The speaker unit 1 further includes electrodes. An alternating electrical signal to cause the first piezoelectric driver 21, the second piezoelectric driver 22, and the third piezoelectric driver 23 to vibrate is applied to the electrodes.

The substrate 10 is a plate-like member that serves as a base of the speaker unit 1. The substrate 10 may include a Si (silicon) substrate, a silicon on insulator (SOI) substrate, a germanium substrate, a GaAs (gallium arsenide) substrate, a sapphire substrate, an alumina substrate, a quartz substrate, or the like. Among these, the Si substrate or the SOI substrate is preferably used as the substrate 10 from the viewpoint or the like that micromachining by micro electro mechanical systems (MEMS) is applicable.

Cavities in which the first piezoelectric driver 21, the second piezoelectric driver 22, and the third piezoelectric driver 23 freely vibrate may be provided in the substrate 10. Also, a drive circuit that drives the first piezoelectric driver 21, the second piezoelectric driver 22, and the third piezoelectric driver 23 may be provided on the substrate 10.

The first piezoelectric driver 21, the second piezoelectric driver 22, and the third piezoelectric driver 23 are members each of which is a generating source of an acoustic wave. As shown in FIG. 2, the first piezoelectric driver 21, the second piezoelectric driver 22, and the third piezoelectric driver 23 are disposed at different positions on the substrate 10.

In this description, “piezoelectric drivers” that include the first piezoelectric driver 21, the second piezoelectric driver 22, and the third piezoelectric driver 23 are members each of which includes (i) a piezoelectric element that is expanded and contracted while deforming in accordance with an applied voltage, and (ii) a diaphragm that vibrates ambient air in accordance with expanded or contraction of the piezoelectric element. In accordance with the vibration of the diaphragm, an acoustic wave having an audible frequency is output from each piezoelectric driver.

The first piezoelectric driver 21 includes, for example, a diaphragm and a piezoelectric element that is laminated on the diaphragm. For example, the second piezoelectric driver 22 includes a diaphragm and a piezoelectric element that are different from the diaphragm and the piezoelectric element of the first piezoelectric driver 21. The third piezoelectric driver 23 includes, for example, a diaphragm and a piezoelectric element that are different from the diaphragms and the piezoelectric elements of the first piezoelectric driver 21 and the second piezoelectric driver 22. The diaphragm of the first piezoelectric driver 21, the diaphragm of the second piezoelectric driver 22, and the diaphragm of the third piezoelectric driver 23 are supported at different positions on the substrate 10.

The diaphragms of the first piezoelectric driver 21, the second piezoelectric driver 22, and the third piezoelectric driver 23 may be made of the same material as that of the substrate 10. For example, when the substrate 10 is a Si substrate, the diaphragms may be made of Si. Each piezoelectric element is a layer including a piezoelectric material that converts applied electrical energy into mechanical energy. As each piezoelectric element, a piezoelectric thin film containing ZnO (zinc oxide), AlN (aluminum nitride), and PZT (lead zirconate titanate), and the like may be used.

As shown in FIG. 2, in the present embodiment, an acoustic wave having a low frequency range is generated through the first piezoelectric driver 21 having the largest area. Then, an acoustic wave having a middle frequency range is generated through the second piezoelectric driver 22 having the second largest area. Subsequently, an acoustic wave having a high frequency range is generated through the third piezoelectric driver 23 having the smallest area. However, the respective frequency ranges in the first piezoelectric driver 21, the second piezoelectric driver 22, and the third piezoelectric driver 23 do not depend only on the areas of the drivers. That is, the magnitude of the frequency ranges in the first piezoelectric driver 21, the second piezoelectric driver 22, and the third piezoelectric driver 23 is not limited to the above example. The magnitude of the frequency ranges in the first piezoelectric driver 21, the second piezoelectric driver 22, and the third piezoelectric driver 23 may be adjusted in consideration of other characteristics of the first piezoelectric driver 21, the second piezoelectric driver 22, and the third piezoelectric driver 23.

The first piezoelectric driver 21, the second piezoelectric driver 22, and the third piezoelectric driver 23 vibrate at different frequencies. For example, the first piezoelectric driver 21 vibrates in a frequency range of 20 Hz to 250 Hz. The second piezoelectric driver 22 vibrates in a frequency range of 200 Hz to 2 kHz. The third piezoelectric driver 23 vibrates in a frequency range of 2 kHz to 20 kHz. However, the vibration frequency of each of the first piezoelectric driver 21, the second piezoelectric driver 22, and the third piezoelectric driver 23 is not limited to the above example.

The frequency range for each of the first piezoelectric driver 21, the second piezoelectric driver 22, and the third piezoelectric driver 23 may overlap a portion of the frequency range of other piezoelectric drivers. A total number of piezoelectric drivers is not limited to three, and may be two, or may be four or more.

As shown in FIGS. 1 and 3, the housing 30 is a box-like member that includes an upper wall 31, a front wall 32F, a rear wall 32R, a first sidewall 32S1, and a second sidewall 32S2. The upper wall 31, the front wall 32F, the rear wall 32R, the first sidewall 32S1, and the second sidewall 32S2 are examples of a “wall surface” of the housing 30.

The housing 30 covers the substrate 10, the first piezoelectric driver 21, the second piezoelectric driver 22, and the third piezoelectric driver 23. These piezoelectric drivers are provided on the substrate 10.

As shown in FIG. 3, the housing 30 includes a first housing portion 41, a second housing portion 42, and a third housing portion 43 that are recessed toward an upper wall 31-side. The first housing portion 41 houses the first piezoelectric driver 21. The second housing portion 42 houses the second piezoelectric driver 22. The third housing portion 43 houses the third piezoelectric driver 23.

That is, the first piezoelectric driver 21, the second piezoelectric driver 22, and the third piezoelectric driver 23 are respectively housed in separate housing portions. In this arrangement, the acoustic wave having the low frequency range that is generated through the first piezoelectric driver 21, the acoustic wave having the middle frequency range that is generated through the second piezoelectric driver 22, and the acoustic wave having the high frequency range that is generated through the third piezoelectric driver 23 are propagated in discrete spaces of the housing 30, and the resulting acoustic waves can be output to the outside of the housing 30.

In the present embodiment, the first housing portion 41 and the second housing portion 42 are separated by a partition 51. The first housing portion 41 and the third housing portion 43 are separated by a partition 52. The second housing portion 42 and the third housing portion 43 are separated by a partition 53. That is, regions of the first housing portion 41, the second housing portion 42, and the third housing portion are separated by corresponding partitions among the partitions 51, 52, and 53.

The first housing portion 41 and the second housing portion 42 have rectangular shapes, but are not limited to the rectangle shapes. The third housing portion 43 has a circular shape, but is not limited to the circular shape.

Each of the first housing portion 41, the second housing portion 42, and the third housing portion 43 has through holes in communication with the outside of the housing 30. Specifically, the first housing portion 41 has through holes 33. As shown in FIGS. 1 and 3, the through holes 33 may have through holes 33a, 33b, and 33c. However, the number of through holes 33 that are provided in the first housing portion 41 is not limited to three. The through holes 33 are an example of a “first through hole.”

Each of the through holes 33a, 33b, and 33c has a rectangular planar shape, but the planar shape of each of the through holes 33a, 33b, and 33c is not limited to a rectangle. The through holes 33a, 33b, and 33c are aligned along a given direction, and any given two holes among the through holes 33a, 33b, and 33c are next to each other. However, the through holes 33a, 33b, and 33c may be arranged at any positions or along any direction.

The second housing portion 42 includes a through hole 34. The through hole 34 has a rectangular planar shape, but the planar shape of the through hole 34 is not limited to a rectangle. The number of through holes 34 is not limited to one, and may be a plurality. A region of the through hole 34 is not limited to the region shown in FIGS. 1 and 3. The through hole 34 is an example of a “first through hole.”

The third housing portion 43 includes a through hole 35. The through hole 35 has a circular planar shape, but the planar shape of the through hole 35 is not limited to a circle. The number of through holes 35 is not limited to one, and may be a plurality. A region of the through hole 35 is not limited to the region shown in FIGS. 1 and 3. The through hole 35 is an example of a “first through hole.”

The housing 30 includes, for example, through holes 36a, 36b, and 36c in sidewalls of the front wall 32F, the first sidewall 32S1, and the like. Preferably, each of the through holes 36a, 36b, and 36c communicates with any one among the first housing portion 41, the second housing portion 42, and the third housing portion 43. The through holes 36a, 36b, and 36c are examples of a “second through hole.”

A portion of air that escapes in response to vibration by the first piezoelectric driver 21, the second piezoelectric driver 22, and the third piezoelectric driver 23 passes through the through holes 36a, 36b, and 36c. That is, the through holes 36a, 36b, and 36c function as passages for the air that escapes in response to the vibration of the first piezoelectric driver 21, the second piezoelectric driver 22, and the third piezoelectric driver 23. As a result, for example, a situation or the like in which acoustic waves generated through the first piezoelectric driver 21 interfere with each other in the first housing portion 41, and thus an acoustic pressure is reduced, can be avoided. Such an effect of avoiding a reduced acoustic pressure is obtained as in the second piezoelectric driver 22 and the third piezoelectric driver 23.

By appropriately varying opening areas and/or positions of the through holes 36a, 36b, and 36c, the acoustic pressure, sound quality, and the like of the acoustic waves to be output to the outside of the housing 30 can be adjusted. The number of through holes that have the same function as described in the through holes 36a, 36b, and 36c is not limited to three. Such a number may be two, or may be four or more.

### Effects

In the present embodiment, multiple piezoelectric drivers (the first piezoelectric driver 21, the second piezoelectric driver 22, and the third piezoelectric driver 23) each of which generates an acoustic wave having a different frequency range are arranged on one substrate 10, and further, the housing 30 covers the multiple piezoelectric drivers. In this arrangement, the speaker unit 1 having a configuration in which acoustic waves having a plurality of frequency ranges are output can be made compact.

The housing 30 is an integral member, and thus the number of components in the speaker unit 1 can be reduced. In this arrangement, the speaker unit 1 can be manufactured at reduced costs.

In the present embodiment, piezoelectric drivers can be individually housed in the respective housing portions 41, 42, and 43 of the housing 30. In this arrangement, acoustic waves having different frequency ranges can be propagated in discrete spaces, and the acoustic waves having the different frequency ranges can be separately output through the housing 30. As a result, without reducing the acoustic pressure and sound quality in multiple different frequency ranges, sound of high quality can be provided completely.

Further, when the speaker unit 1 is applied, for example, to an earpiece, a percentage of a volume of the speaker unit 1 in an inner space of the earpiece can be reduced because the speaker unit 1 is made compact. In this arrangement, an echo sound space in the earpiece can be increased, and the sound quality of the sound that is output from the speaker unit 1 can be further improved.

### Application Example

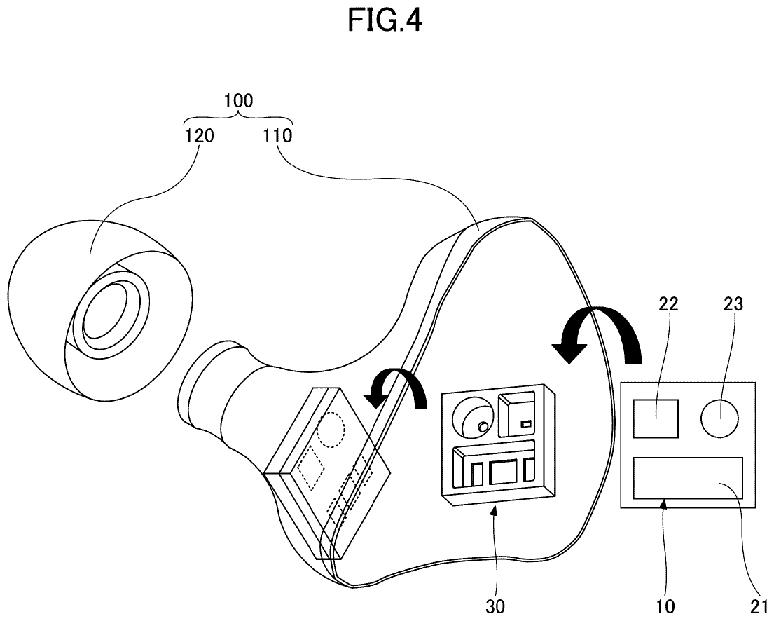

Hereinafter, an earpiece 100 in which the speaker unit 1 according to the first embodiment is incorporated will be described with reference to FIG. 4. FIG. 4 is a schematic diagram showing a structure of the earpiece 100.

As shown in FIG. 4, the earpiece 100 includes a body 110 that houses the speaker unit 1 according to the first embodiment, and includes an ear pad 120 that is to be fitted into an earhole of a user.

When the speaker unit 1 is housed in the body 110, the upper wall 31 of the housing 30 faces the ear pad 120. That is, the through holes 33, 34, and 35 of the housing 30 can be directed toward a sound-outlet side of the earpiece 100. In this arrangement, the acoustic waves having different frequency ranges that pass through the through holes 33, 34, and 35 can be output from a portion of the earpiece 100 proximate to an earpiece outlet.

### Second Embodiment

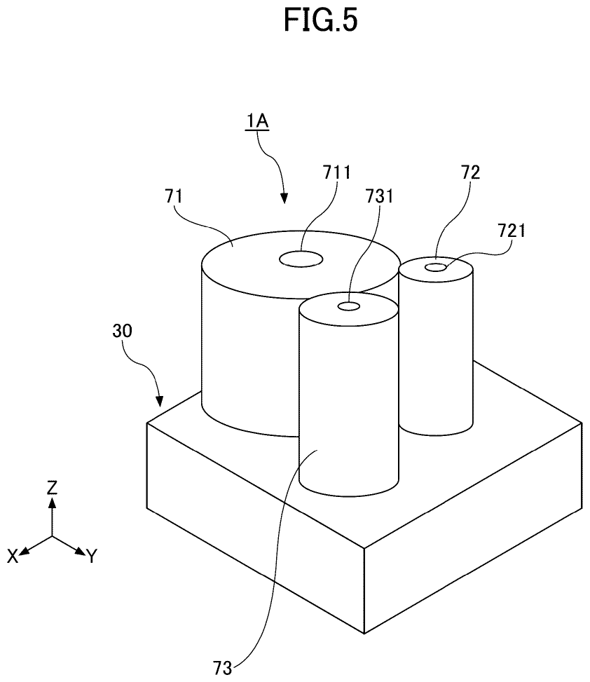

Hereinafter, a speaker unit 1A according to a second embodiment will be described with reference to FIG. 5. FIG. 5 is a perspective view of the speaker unit 1A according to the second embodiment when viewed from the +Z side direction. In the second embodiment, description of the same components as described in the first embodiment is omitted as appropriate.

As shown in FIG. 5, the speaker unit 1A according to the second embodiment further includes multiple cylindrical portions 71, 72, and 73. The cylindrical portions 71, 72, and 73 protrude from the housing 30 in the +Z side direction.

A top end of the first cylindrical portion 71 that is disposed at the upper wall 31 of the housing 30 faces toward the first housing portion 41. In this arrangement the through holes 33 communicate with a hole 711 that penetrates the first cylindrical portion 71 in a thickness direction.

A top end of the second cylindrical portion 72 that is disposed at the upper wall 31 of the housing 30 faces toward the second housing portion 42. In this arrangement, the through hole 34 communicates with a hole 721 that penetrates the second cylindrical portion 72 in the thickness direction.

A top end of the third cylindrical portion 73 that is disposed at the upper wall 31 of the housing 30 faces toward the third housing portion 43. In this arrangement, the through hole 35 communicates with a hole 731 that penetrates the third cylindrical portion 73 in the thickness direction.

When the first cylindrical portion 71, the second cylindrical portion 72, and the third cylindrical portion 73 are coupled to the housing 30, acoustic waves generated through the first piezoelectric driver 21, the second piezoelectric driver 22, and the third piezoelectric driver 23 can be propagated further in a manner so as to separate the acoustic waves. As a result, it is possible to avoid a situation or the like in which the sound quality is reduced due to interference between acoustic waves in different frequency ranges. That is, it is not necessary to adjust the acoustic pressure of each acoustic wave to a high level in an expected situation in which the acoustic waves in the different frequency ranges interfere in advance. As a result, the area of each piezoelectric driver can be reduced, thereby reducing the manufacturing cost. In addition, power consumption of the speaker unit 1A can be reduced. In addition, the speaker unit 1A according to the second embodiment has the same effects as described in the first embodiment.

The preferred embodiments and the like are described above in detail. However, the present disclosure is not limited to the above embodiments. For example, various modifications and substitutions may be made to the above-described embodiment without departing from the scope set forth in the present disclosure.

Aspects of the embodiments are, for example, as follows.
[1] A speaker unit includes:
   a substrate;
   multiple piezoelectric drivers disposed on the substrate, the multiple piezoelectric drivers being configured to generate respective acoustic waves having different frequency ranges; and
   a housing integrally including multiple housing portions that house the respective piezoelectric drivers.
[2] In a speaker unit in [1], multiple housing portions may include respective first through holes in communication with an exterior of the housing, and acoustic waves generated through multiple piezoelectric drivers that are housed in the housing portions are each configured to be output through a corresponding through hole among the first through holes.
[3] In a speaker unit in [1] or [2], a speaker unit further includes multiple cylindrical portions provided facing respective housing portions, and a housing may include a wall surface disposed between the cylindrical portions and housing portions.
[4] In a speaker unit in any one of [1] to [3],a housing may include a second through hole through which air escaping in accordance with vibration of piezoelectric drivers is to pass.
[5] An earpiece includes a speaker unit including
   a substrate,
   multiple piezoelectric drivers disposed on the substrate, the multiple piezoelectric drivers being configured to generate respective acoustic waves having different frequency ranges, and
   a housing integrally including multiple housing portions that house the respective piezoelectric drivers.

In the present disclosure, a speaker unit and an earpiece that are made compact can be provided.

What is claimed is:

1. A speaker unit comprising:
a substrate;
multiple piezoelectric drivers disposed on the substrate, the multiple piezoelectric drivers being configured to generate respective acoustic waves having different frequency ranges; and
a housing integrally including multiple housing portions that house the respective piezoelectric drivers.

2. The speaker unit according to claim 1, wherein the multiple housing portions include respective first through holes in communication with an exterior of the housing, and
wherein the acoustic waves generated through the multiple piezoelectric drivers that are housed in the respective housing portions are each configured to be output through a corresponding through hole among the first through holes.

3. The speaker unit according to claim 1, further comprising:
multiple cylindrical portions provided facing the respective housing portions,
wherein the housing includes a wall surface disposed between the cylindrical portions and the housing portions.

4. The speaker unit according to claim 1, wherein the housing includes a second through hole through which air escaping in accordance with vibration of the piezoelectric drivers is to pass.

5. An earpiece comprising:
a speaker unit including
a substrate,
multiple piezoelectric drivers disposed on the substrate, the multiple piezoelectric drivers being configured to generate respective acoustic waves having different frequency ranges, and
a housing integrally including multiple housing portions that house the respective piezoelectric drivers.
